(19) United States
(12) Patent Application Publication
(10) Pub. No.: US 2012/0066560 A1
(43) Pub. Date: Mar. 15, 2012

(54) ACCESS METHOD OF VOLATILE MEMORY AND ACCESS APPARATUS OF VOLATILE MEMORY

(76) Inventors: Hai-Feng Chuang, Taipei County (TW); Po-Hsiang Wang, Hsinchu City (TW); Chao-Nan Chen, Taipei City (TW); Chao-Yin Liu, Hsinchu City (TW)

(21) Appl. No.: 12/985,349

(22) Filed: Jan. 6, 2011

(30) Foreign Application Priority Data
Sep. 10, 2010 (TW) 099130626

(51) Int. Cl. G06F 11/20

(52) U.S. Cl. 714/710; 714/773; 714/E11.087

(57) ABSTRACT

An access method of a volatile memory accesses the volatile memory via a block access fashion. The volatile memory includes a plurality of blocks. The method includes: performing a reading operation for a block having at least one known bad cell among the blocks, which includes reading a block data and an error correction code data corresponding to the block and applying the ECC data to correct data read from the at least one known bad cell to generate a corrected block data.

### BACKGROUND OF THE INVENTION

1. Field of the Invention

The present invention relates to an access method and related apparatus of a volatile memory, and more particularly, to an access method and related apparatus capable of accessing a volatile memory having bad cells.

2. Description of the Prior Art

For a typical volatile memory, once a bad/downgraded cell is detected in the volatile memory, the memory blocks containing the bad/downgraded cells will be excluded and only the remaining memory blocks will be utilized. In conventional implementations, however, a large amount of memory space is discarded for ruling out a few bad/downgraded cells, leading to a degradation of the overall system performance.

### SUMMARY OF THE INVENTION

In light of this, the present invention provides an access method and related apparatus to fully utilize memory space and enhance system performance.

According to a first embodiment of the present invention, an access method of a volatile memory is provided for accessing the volatile memory via a block access fashion. The volatile memory includes a plurality of blocks. The access method includes performing a reading operation for a block having at least one known bad cell among the blocks, which comprises: reading a block data and an error correction code (ECC) data corresponding to the block, and applying the ECC data to correct data read from the known bad cell to generate a corrected block data.

According to a second embodiment of the present invention, an access method of a volatile memory is provided for accessing the volatile memory via a block access fashion. The volatile memory comprises a plurality of blocks. The access method includes performing a writing operation for a block having at least one known bad cell among the blocks, which comprises: generating an ECC data according to an original block data, and writing the ECC data into the volatile memory and writing the original block data into the block, wherein partial data of the original block data is written into the known bad cell.

According to a third embodiment of the present invention, an access apparatus of a volatile memory is provided for accessing the volatile memory via a block access fashion. The volatile memory comprises a plurality of blocks. The access apparatus includes a reading element and an error correction controller. The reading element is for reading a block data and an error correction code (ECC) data corresponding to a block having at least one known bad cell among the blocks. The error correction controller is for applying the ECC data to correct data read from the known bad cell to generate a corrected block data.

According to a fourth embodiment of the present invention, an access apparatus of a volatile memory is provided for accessing the volatile memory via a block access fashion. The volatile memory comprises a plurality of blocks. The access apparatus includes a reading element and an error correction controller. The reading element is for reading a block data and an ECC data corresponding to a block having at least one known bad cell among the blocks. The error correction controller is for applying the ECC data to correct data read from the known bad cell to generate a corrected block data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an access apparatus according to an embodiment of the present invention.

FIG. 2 is a diagram of utilizing the access apparatus in FIG. 1 to read a volatile memory according to an embodiment of the present invention.

FIG. 3 is a diagram of an access apparatus according to an embodiment of the present invention.

FIG. 4 is a diagram of utilizing the access apparatus in FIG. 3 to read a volatile memory according to an embodiment of the present invention.

FIG. 5 is a diagram of an access apparatus according to another embodiment of the present invention.

### DETAILED DESCRIPTION

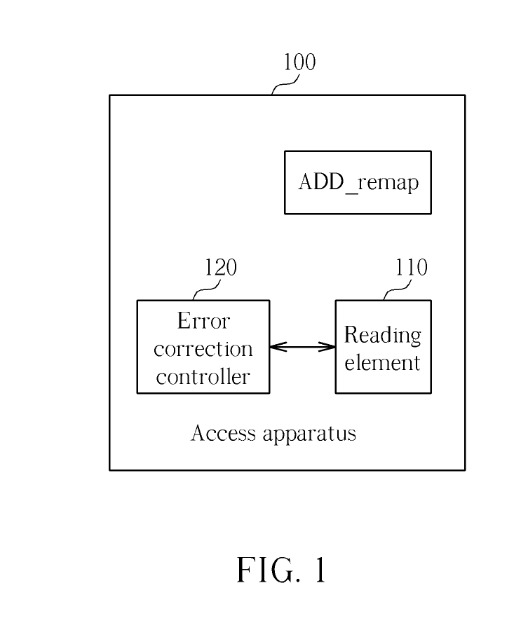

Please refer to FIG. 1, which is a diagram of an access apparatus 100 according to an embodiment of the present invention. The access apparatus 100 is for accessing a volatile memory, e.g., a dynamic random access memory (DRAM) or a static random access memory (SRAM), via a block access fashion. The access apparatus 100 includes (but is not limited to) a reading element 110 and an error correction controller 120, and the volatile memory includes a plurality of blocks. Before the access apparatus 100 and the volatile memory begin normal operation (i.e., performing reading or writing processes), the manufacturer of the volatile memory detects a distribution status and a number of bad cells in the volatile memory. For a bad block having a number of bad cells exceeding an error correction threshold TH in the blocks, the manufacturer remaps the addresses of the detected bad cells in the bad block such that at least one of the bad cells of the detected bad cells is remapped to a target block other than the bad block to thereby generate an address remap configuration ADD_remap, wherein after the operation of remapping addresses of the detected bad cells in all the bad blocks is accomplished, each block in the plurality of blocks has a number of bad cells not exceeding the error correction threshold TH. The reading element 110 is for reading a block data and an error correction code (ECC) data corresponding to a block having at least one known bad cell after remapping. The error correction controller 120 utilizes the ECC data to correct data read from the bad cell in the block and therefore generate a corrected block data.

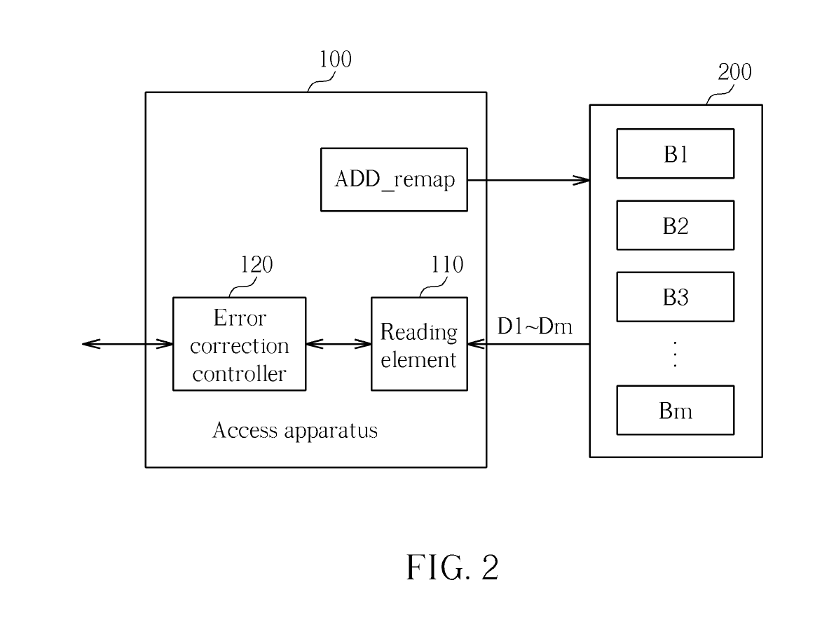

Please refer to FIG. 2, which is a diagram of utilizing the access apparatus 100 to read a volatile memory 200 according to an embodiment of the present invention. For example, the volatile memory 200 has m blocks B1-Bm, wherein only a first block B1 (i.e., the bad block having at least one bad cell) has N1 bad cells, and there is no bad cell in the other blocks B2-Bm. In this case, the manufacturer, before the reading operation is normally applied to the volatile memory 200, detects that the first block B1 contains N1 bad cells, and the manufacturer then determines a following operation according to whether the number of bad cells N1 exceeds the error correction threshold TH or not. If the number of bad cells is less than the error correction threshold TH (N1<TH), the volatile memory 200 directly starts a reading operation; when the number of bad cells is more than the error correction threshold TH (N1>TH), the manufacturer will remap the addresses of the bad cells, distribute at least one bad cell into the other blocks B1-Bm) until a number of bad cells in each block is less than the error correction threshold TH and generate the memory address remap configuration ADD_remap to remap the blocks in the volatile memory 200. After that, the access apparatus 100 starts the reading operation.

After ensuring each block having a number of bad cells is less than the error correction threshold TH, the reading element 110 will read a block data corresponding to each block, respectively. At first, the reading element 110 will read a first block data D1 of the first block B1 and an error correction code (ECC) data ECC1 corresponding to the first block B1. Next, the error correction controller 120 will utilize the error correction code data ECC1 to correct errors in the first data block D1 to generate a first corrected block data. In this embodiment, the error correction code data ECC1 is a parity which is generated according to the error correction threshold TH, therefore, the number of error that can be corrected by the first block data D1 and the error correction code data ECC1 is TH, and the first block B1 has N1 bad cells (N1<TH). As a result, the error correction controller 120 is able to refer to the error correction code data ECC1 and the first block data D1 to easily correct errors resulting from the bad cells in the first block B1. Likewise, the access apparatus 100 will read block data D1-Dm in blocks B1-Bm and corresponding error correction code data ECC1-ECCm, respectively. Since the number of bad cells in each block of the blocks B1-Bm is less than the error correction threshold TH, the error resulting from the bad cell in each block can be thereby corrected via the error correction controller 120. In this way, even if bad cells exist in the volatile memory 200, the access apparatus 100 can still fully utilize valid memory space in the volatile memory 200 without discarding blocks containing bad cells.

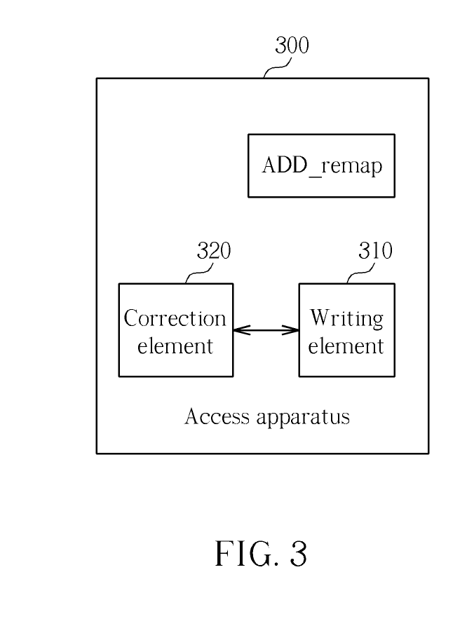

Please refer to FIG. 3, which is a diagram of an access apparatus 300 according to an embodiment of the present invention. The access apparatus 300 is for accessing a volatile memory, e.g., a DRAM or an SRAM, via a block access fashion. The access apparatus 300 includes (but is not limited to) a writing element 310 and a correction element 320, and the volatile memory includes a plurality of blocks. Before the access apparatus 300 and the volatile memory begin normal operation (i.e., performing reading or writing processes), the manufacturer of the volatile memory detects a distribution status and a number of bad cells in the volatile memory for a bad block having a number of bad cells exceeding an error correction threshold TH in the blocks. The manufacturer remaps the addresses of the detected bad cells in the bad block such that at least one of the bad cells of the detected bad cells is remapped to a target block other than the bad block to thereby generate the address remap configuration ADD_remap, wherein after the operation of remapping addresses of the detected bad cells in all the bad blocks is accomplished, each block in the plurality of blocks has a number of bad cells not exceeding the error correction threshold TH. The correction element 320 generates an error correction code data according to an original block data, and the writing element 310 then writes the error correction code data into the volatile memory, and writes the original block data into a block, wherein partial data of the original block data is written into the known bad cell in the block.

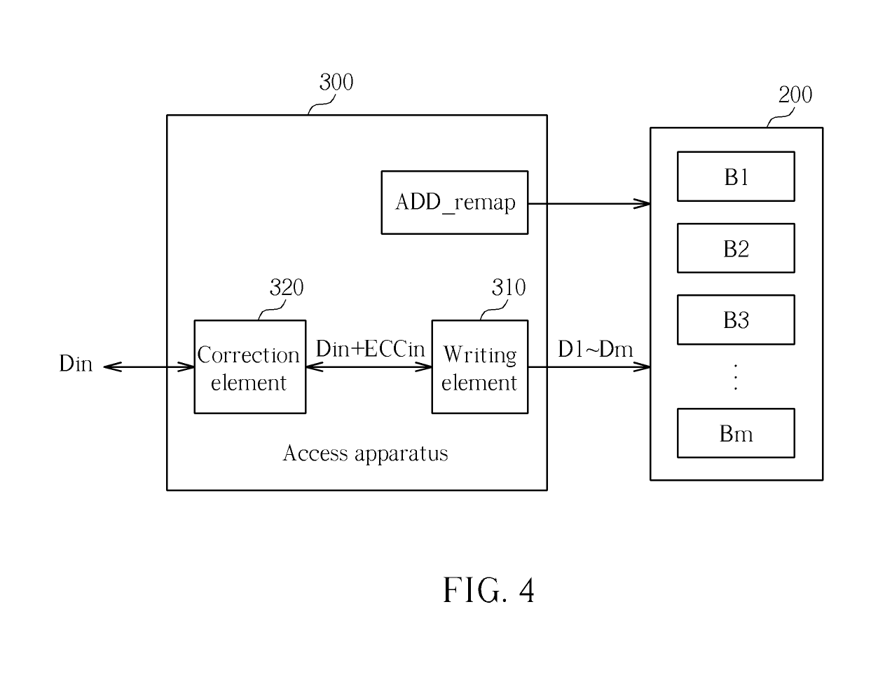

Please refer to FIG. 4, which is a diagram of utilizing the access apparatus 300 to read the volatile memory 200 according to an embodiment of the present invention. The volatile memory 200 has m blocks B1-Bm. As in the above, the manufacturer, after ensuring each block having a number of bad cells is less than the error correction threshold TH, generates the memory address remap configuration ADD_remap to remap the blocks in the volatile memory 200. The correction element 320 generates an error correction code data ECCin according to a block data Din. The writing element 310 is coupled to the correction element 320 for writing the error correction data ECCin into the volatile memory 200 and writing the original block data Din into one of the blocks B1-Bm. In this embodiment, partial data of the original block data Din is written into the block B1 containing at least one known bad cell. In this way, even if the block B1 includes known bad cells, the original block data Din can still be read correctly with the help of the error correction code data ECCin.

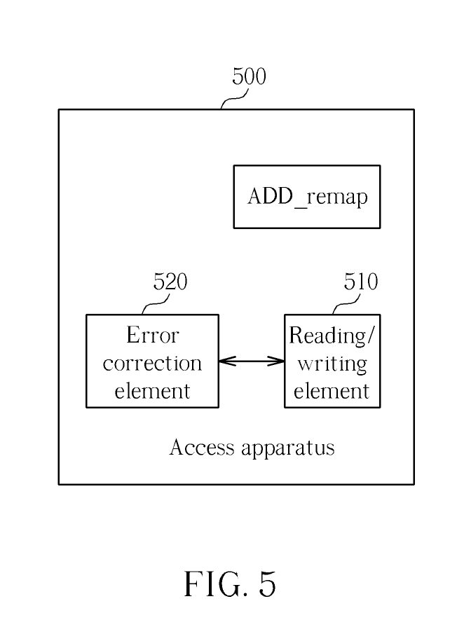

The aforementioned embodiments are examples illustrative of the spirit of the present invention, and are not supposed to be limitations to the present invention. For example, the access apparatus 100 and the access apparatus 300 can also be integrated into one single apparatus. Please refer to FIG. 5, which is a diagram of an access apparatus according to an embodiment of the present invention. The access apparatus 500 includes a reading/writing element 510 and an error correction element 520. The manufacturer redistributes addressed bad cells to ensure each block having a number of bad cells is less than the error correction threshold TH, and thereby generates the memory address remap configuration ADD_remap to remap the blocks in the volatile memory 200. The reading/writing element 510 includes the functionalities of both the reading element 110 in FIG. 1 and the writing element 310 in FIG. 3, for performing a reading or writing operation at different phases. The error correction element 520 includes the functionalities of both the error correction controller 120 in FIG. 1 and the correction element 320 in FIG. 3, for performing different functions at different phases. In addition, the memory address remap configuration ADD_remap is also not limited to be provided by the manufacturer only. By way of example, but not limitation, the memory address remap configuration ADD_remap can also be internally updated by performing a periodic scanning (e.g., once a month) upon a corresponding volatile memory by the access apparatus 500. In this way, even if new bad cells are generated in the volatile memory over time, the access apparatus 500 can still rule out the influence resulting from those newly formed bad cells, and therefore the lifetime of the volatile memory can be extended. These kinds of variation in design still belong to the scope of the present invention.

To summarize, the present invention provides an access method and related apparatus capable of accessing a volatile memory containing bad cells via redistributing addresses of bad cells into each block, and correcting block data in the bad cells by the utilization of error correction codes. In this way, the memory space can be fully used and therefore the system performance can be enhanced.

Those skilled in the art will readily observe that numerous modifications and alterations of the device and method may be made while retaining the teachings of the invention.

What is claimed is:

1. An access method of a volatile memory for accessing the volatile memory via a block access fashion, the volatile memory comprising a plurality of blocks, the access method comprising:
performing a reading operation for a block having at least one known bad cell among the blocks, comprising:
reading a block data and an error correction code (ECC) data corresponding to the block; and
applying the ECC data to correct data read from the at least one known bad cell to generate a corrected block data.

2. The access method of claim 1, further comprising:
performing an initialization arrangement process before the reading operation, wherein the initialization arrangement process comprises:
detecting a distribution status and a number of bad cells in the volatile memory; and
for each specific block having a number of bad cells exceeding an error correction threshold in the blocks, remapping addresses of the detected bad cells in the specific block such that at least one of the bad cells of the detected bad cells is distributed to the other blocks of the plurality of blocks, wherein after remapping addresses of the detected bad cells in all the specific blocks is accomplished, each block in the plurality of blocks has a number of bad cells not exceeding the error correction threshold.

3. The access method of claim 1, wherein the volatile memory is a dynamic random access memory (DRAM) or a static random access memory (SRAM).

4. An access method of a volatile memory for accessing the volatile memory via a block access fashion, the volatile memory comprising a plurality of blocks, the access method comprising:
performing a writing operation for a block having at least one known bad cell among the blocks, comprising:
generating an error correction code (ECC) data according to an original block data; and
writing the ECC data into the volatile memory and writing the original block data into the block, wherein partial data of the original block data is written into the at least one known bad cell.

5. The access method of claim 4, further comprising:
performing an initialization arrangement process before the writing operation, wherein the initialization arrangement process comprises:
detecting a distribution status and a number of bad cells in the volatile memory; and
for each specific block having a number of bad cells exceeding an error correction threshold in the blocks, remapping addresses of the detected bad cells in the specific block such that at least one of the bad cells of the detected bad cells is distributed to the other blocks of the plurality of blocks, wherein after remapping addresses of the detected bad cells in all the specific blocks is accomplished, each block in the plurality of blocks has a number of bad cells not exceeding the error correction threshold.

6. The access method of claim 4, wherein the volatile memory is a dynamic random access memory (DRAM) or a static random access memory (SRAM).

7. An access apparatus of a volatile memory for accessing the volatile memory via a block access fashion, the volatile memory comprising a plurality of blocks, the access apparatus comprising:
a reading element, for reading a block data and an error correction code (ECC) data corresponding to a block having at least one known bad cell among the blocks; and
an error correction controller, coupled to the reading element, for applying the ECC data to correct data read from the at least one known bad cell to generate a corrected block data.

8. The access apparatus of claim 7, further comprising a memory address remap configuration;
wherein the memory address remap configuration is for remapping addresses of detected bad cells in each specific block such that at least one of the bad cells of the detected bad cells is distributed to the other blocks of the plurality of blocks; and after remapping addresses of the detected bad cells in all the specific blocks is accomplished, each block in the plurality of blocks has a number of bad cells not exceeding the error correction threshold.

9. The access apparatus of claim 7, wherein the volatile memory is a dynamic random access memory (DRAM) or a static random access memory (SRAM).

10. An access apparatus of a volatile memory for accessing the volatile memory via a block access fashion, the volatile memory comprising a plurality of blocks, the access apparatus comprising:
a correction element, for generating an error correction code (ECC) data according to an original block data; and
a writing element, coupled to the correction element, for writing the ECC data into the volatile memory and writing the original block data into the block, wherein partial data of the original block data is written into the at least one known bad cell.

11. The access method of claim 10, further comprising a memory address remap configuration;
wherein the memory address remap configuration is for remapping addresses of detected bad cells in each specific block such that at least one of the bad cells of the detected bad cells is distributed to the other blocks of the plurality of blocks; and after remapping addresses of the detected bad cells in all the specific blocks is accomplished, each block in the plurality of blocks has a number of bad cells not exceeding the error correction threshold.

12. The access apparatus of claim 10, wherein the volatile memory is a dynamic random access memory (DRAM) or a static random access memory (SRAM).
